(19) United States
(12) Patent Application Publication
(10) Pub. No.: US 2024/0198547 A1
(43) Pub. Date: Jun. 20, 2024

(54) SHAVER

(71) Applicant: BIC Violex Single Member S.A., Anoixi (GR)

(72) Inventors: Panagiotis KOPELAS, Anoixi (GR); Ioannis PSOMIADIS, Anoixi (GR); Georgios TSIAKATOURAS, Anoixi (GR)

(73) Assignee: BIC Violex Single Member S.A., Anoixi (GR)

(21) Appl. No.: 18/540,233

(22) Filed: Dec. 14, 2023

(30) Foreign Application Priority Data
Dec. 14, 2022 (EP) 22213571.7

(51) Int. Cl. B26B 21/22; B26B 21/44; B26B 21/52

(52) U.S. Cl. CPC B26B 21/227; B26B 21/225; B26B 21/443; B26B 21/521

(57) ABSTRACT

A shaving unit and a shaver having an adjustable blade exposure, comprising a guard base, including a guard bar and defining a guard plane, and a blade assembly, including at least one blade extending in a blade direction and defining a blade plane, wherein the blade assembly is pivoting with respect to the guard base about a first pivot axis parallel to the blade direction.

### CROSS-REFERENCE TO RELATED APPLICATIONS

This application claims benefit from European patent application EP22213571.7, filed on Dec. 14, 2022, its content being incorporated herein by reference.

### TECHNICAL FIELD

The present disclosure relates to a shaving unit and a shaver having an adjustable blade exposure. Particularly, such a shaving unit may contribute to increase the efficiency and the safety of the shaving operation.

### Technological Background

Hand-held shavers nowadays commonly comprise a pivot axis between the shaving unit, including the blades, and the handle in order to help the shaving unit to follow the curvature of the skin even if the handle is not held by the user in the proper orientation with respect to the skin.

The orientation of the blades and their distance to the skin are therefore better controlled, which contributes to the increase of the shaving efficiency while at the same time mitigating the risk of any nicks and cuts.

However, even if such configurations already yield some results, there is further space for further optimization. Particularly, such configurations are adapted to follow the main curvature of the face or the body but do not allow to properly follow the local relief features of the skin, for instance those caused by protruding bones or else by skin imperfections such as spots.

As a result, there is a real need for a shaving unit and a shaver which enable to further increase the efficiency and the safety of the shaving operation.

### SUMMARY

The present disclosure relates to a shaving unit, comprising
a guard base, including a guard bar and defining a guard plane, and
a blade assembly, including at least one blade extending in a blade direction and defining a blade plane,
wherein the blade assembly is pivoting with respect to the guard base about a first pivot axis parallel to the blade direction.

Thanks to such a shaving unit, the blade assembly, and thus the at least one blade, is pivoting with respect to the guard bar which stretches the skin upstream of the at least one blade. Thus, the blade exposure can be adjusted, either in a positive or negative direction. It is therefore possible to customize the shaving experience.

Further, a pivot axis is provided between the blade assembly and the guard base thereby enabling the shaving unit to follow the contours of the skin, having a smaller radius of curvature in order to improve the efficiency and the safety of the shaving operation even when the skin includes local relief features.

In embodiments, the guard bar extends in the blade direction.

In embodiments, the guard bar is provided upstream of the at least one blade. The guard bar can therefore stretch the skin before the passage of the blades.

In embodiments, the guard bar comprises a plurality of ribs. These ribs are, in examples, substantially parallel and parallel to the blade direction.

In embodiments, the guard bar is elastomeric. This helps the guard bar to stretch the skin upstream of the blades.

In embodiments, the blade assembly includes two or more blades and in examples, three, four, or five or more blades. This helps to increase the efficiency and the safety of the shaving operation.

In embodiments, each blade comprises a cutting edge and edges of all the blades lie on a blade plane.

In embodiments, at least one blade is mobile within the blade assembly. In examples, the blade is mobile in a depth direction of the blade assembly; such blade may also be spring-loaded toward the outer side of the blade assembly. Such a configuration also contributes to adjust the exposure of the blade.

In embodiments, the guard base is a rectangular frame including a socket in which the blade assembly is mounted. The guard base therefore forms a structural frame wherein the blade assembly can be safely secured.

In embodiments, the first pivot axis extends within the blade assembly.

In embodiments, the first pivot axis extends in the middle of the blade assembly in a shaving direction perpendicular to the blade direction. The pivot axis is therefore centered within the blade assembly.

In embodiments, the guard base comprises a slot and the blade assembly comprises a pair of lateral surfaces, and at least one or each of the lateral surfaces of the blade assembly comprises a pin that is engaged in the slot of the guard base. The opposite configuration is also possible: each lateral surface of the blade assembly may comprise a slot in which pins of the guard base are engaged. In examples, these pins are snap-fitted in the slots.

In embodiments, the guard base is a beam extending in the blade direction, and the blade assembly is mounted on the downstream side of the guard base. In such a configuration, the shaving unit comprises two main parts which are provided side-by-side in a pivotal fashion. Therefore, the blade assembly may move above or below the guard plane.

In embodiments, the first pivot axis extends within the guard base.

In embodiments, a clearance greater than 0.05 mm, greater than 0.5 mm, or greater than 1 mm, is provided between the upstream surface of the blade assembly and the guard base and/or between the downstream surface of the blade assembly and the guard base.

In embodiments, the at least one blade forms an angle with the guard plane wherein the angle is of about 20-30°.

In embodiments, the maximum amplitude of the pivotal movement between the blade assembly and the guard base is comprised between 10 and 100°, between 30 and 90°, or between 50 and 80°.

In embodiments, the maximum negative angle between the guard plane and the blade plane is comprised between 0 and −50°, between 0 and −40°. Such a maximum negative angle enables to keep an exposure which remains efficient during the shaving operation.

In embodiments, the maximum positive angle between the guard plane and the blade plane is comprised between 0 and 50°, between 0 and 40°. Such a maximum positive angle enables to keep an exposure which remains safe during the shaving operation.

In embodiments, the angle between the guard plane and the blade plane is adjustable by hand. The user can therefore adjust the blade exposure in order to customize the shaving experience.

In embodiments, the angle between the guard plane and the blade plane can be locked. The use can therefore lock the pivoting to a specific angle, for instance by choosing an angle along the whole range of pivoting or by pre-defined increments of 5-10 degrees.

In embodiments, the amplitude of the pivotal movement is adjustable by hand. The user can therefore adjust the pivotal movement into a more desirable limited range with respect to the maximum amplitude range.

In embodiments, the blade assembly is spring-loaded with respect to the guard base. In examples, the blade assembly is spring-loaded toward a neutral position wherein the blade plane is parallel with the guard plane.

In embodiments, the shaving unit comprises a lubricant strip. Such a lubricant strip enables to lubricate the skin during the shaving operation.

In embodiments, the lubricant strip is provided downstream of the at least one blade. Depending on the configuration, the lubricant strip may be provided on the frame or on the blade assembly.

In embodiments, the shaving unit comprises a precision blade.

In embodiments, the precision blade is provided on the downstream surface of the shaving unit. Depending on the configuration, the precision blade is provided on the frame or on the blade assembly.

In embodiments, the shaving unit comprises a connecting portion, connected or connectable to a shaver handle.

In embodiments, the shaving unit comprises a second pivot axis, extending in the blade direction, about which the guard base is pivoting with respect to the connection portion.

The present disclosure also relates to a shaver, comprising a shaver handle, and a shaving unit according to any one of the above embodiments.

In embodiments, the shaving unit is removable from the shaver handle.

In embodiments, the shaving unit is integral with the shaver handle.

In the present disclosure, the longitudinal direction corresponds to the shaving direction, that is to say the direction which is orthogonal to the blade direction; the transversal direction is orthogonal to the longitudinal direction and therefore corresponds to the blade direction; the upstream side is the side located ahead of the blades in the shaving direction while the downstream side is the side located after the blades in the shaving direction.

The above mentioned features and advantages, and others, will become apparent when reading the following detailed description of exemplary embodiments of the presented shaving unit and shaver. This detailed description refers to the accompanying drawings.

### BRIEF DESCRIPTION OF THE DRAWINGS

The accompanying drawings are diagrammatic and seek above all to illustrate the principles of the disclosure.

On these drawings, from one figure to another, elements (or element parts) which are identical are marked by the same reference signs. In addition, elements (or element parts) pertaining to different examples but having an analogous function are marked on the figures by reference signs incremented by 100, 200, etc.

FIG. 1 is a perspective view of a first exemplary shaver according to the disclosure.

FIG. 2 is a front view of a first exemplary shaving unit.

FIG. 3 is a front view of the frame of the first shaving unit.

FIG. 4 is a front view of the blade assembly of the first shaving unit.

FIG. 5 is a diagrammatic section view of the first shaving unit in a neutral state.

FIG. 6 is a section view of the first shaving unit in a pivoted state.

FIG. 7 is a section view of a second exemplary shaving unit in a neutral state.

FIG. 8 is a section view of the second exemplary shaving unit in a first pivoted state.

FIG. 9 is a section view of the second exemplary shaving unit in a second pivoted state.

### DETAILED DESCRIPTION OF EMBODIMENTS

Exemplary embodiments of shaving units and shavers are described in detail below with reference to the accompanying drawings. It should be recalled that the disclosure is not limited to these examples.

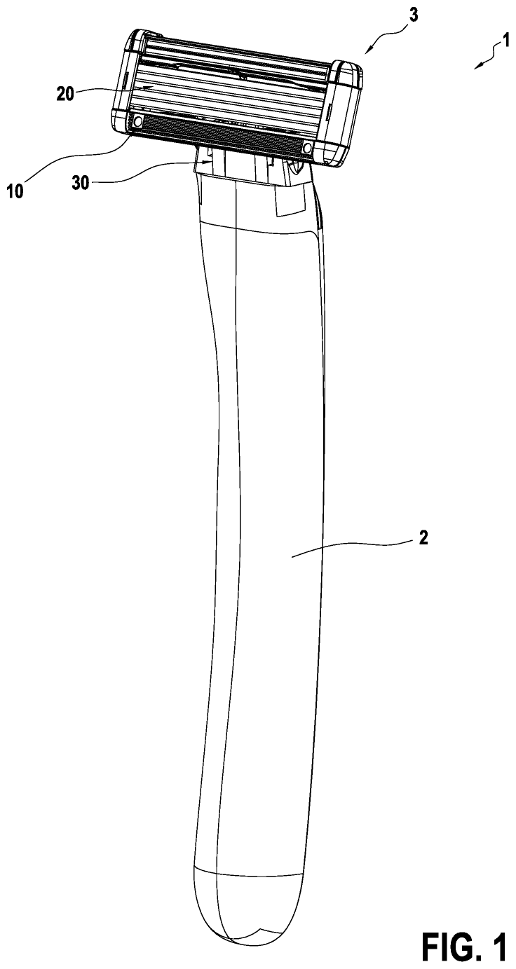

FIG. 1 depicts a first exemplary shaver 1. This shaver 1 comprises a shaver handle 2 and a shaving unit 3 mounted at the upper end of the shaver handle 2.

The shaving unit 3 comprises a guard base 10, a blade assembly 20 and a connection portion 30 able to be attached at the upper end of the shaver handle 2 in a removable fashion. The guard base 10 is attached to the connection portion 30 in a pivotal fashion through a main pivot axis.

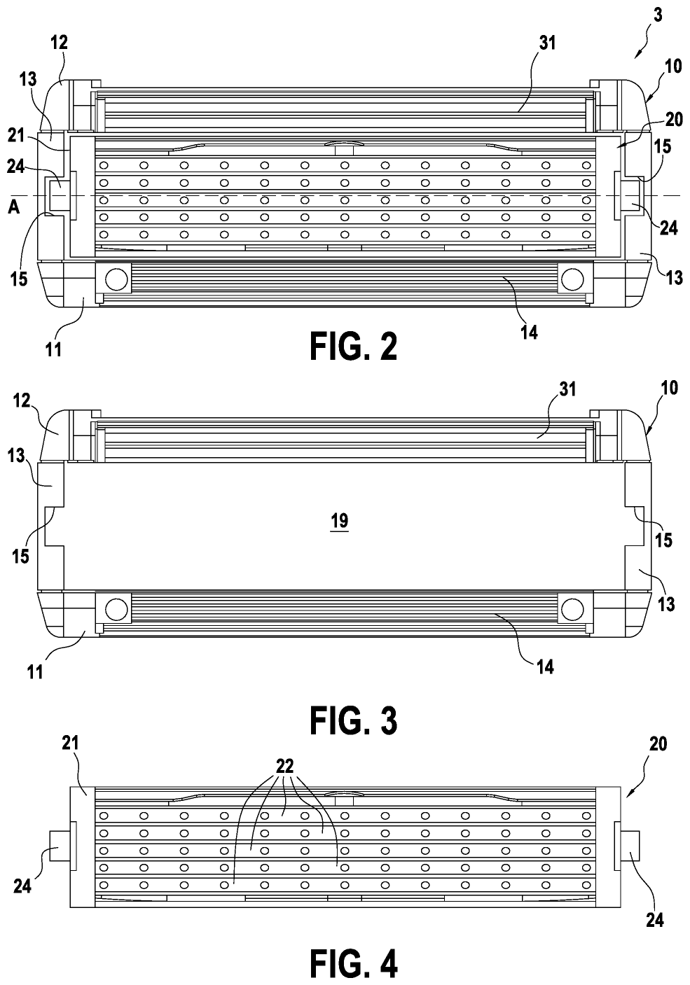

As better seen on FIGS. 2, 3 and 5, the guard base 10 takes the form of a rectangular frame in this first example, having an upstream portion 11, a downstream portion 12 and two lateral portions 13, collectively surrounding a rectangular socket 19.

The upstream portion 11 comprises a guard bar 14, made of elastomeric material, having several ribs 14a extending in the transversal direction of the shaving unit 3. The plane flush with the top of the guard bar 14 is called the guard plane G.

The downstream portion 12 may comprise a lubricant strip or an over molded lubrication element 31, made of suitable lubricating material, extending in the transversal direction of the shaving unit 3. In examples, the downstream portion 12 may comprise a precision blade 32 provided at the downstream surface of the downstream portion 12, the edge of the precision blade 32 extending along the transversal direction and pointing inwards, that is to say in a direction opposite to the guard plane G.

The lateral portions 13 are symmetrical and each comprises a slot 15 located in the middle of the lateral portion 13 along the longitudinal direction and opening in the socket 19.

As better seen on FIGS. 2, 4 and 5, the blade assembly 20 comprises a rectangular body 21 on which several blades 22 are mounted, the edge of each blade 22 extending along the transversal direction and pointing outwards, that is to say toward the guard plane G. In the present example, five blades 22 are provided. Each blade 22 is mounted on the body 21 through a spring-loaded attachment section 23 which biases the blade 22 outwards towards a rest position in which the edge of the blade 22 lies on a blade plane B common to every blade 22.

The body 21 also comprises two opposite pins 24 provided on each lateral surface of the body 21, in the middle of the body 21 along the longitudinal direction.

The blade assembly 20 is received and attached in the socket 19 of the guard base 10 by snap-fitting the pins 24 of the blade assembly 20 into the slots 15 of the guard base 10, thereby forming a blade pivot axis A around which the blade assembly 20 is pivoting, said blade pivot axis A being parallel to the transversal direction.

A clearance c is provided between each of the upstream and downstream surfaces 25, 26 of the blade assembly 20 and the corresponding surface of the socket 19.

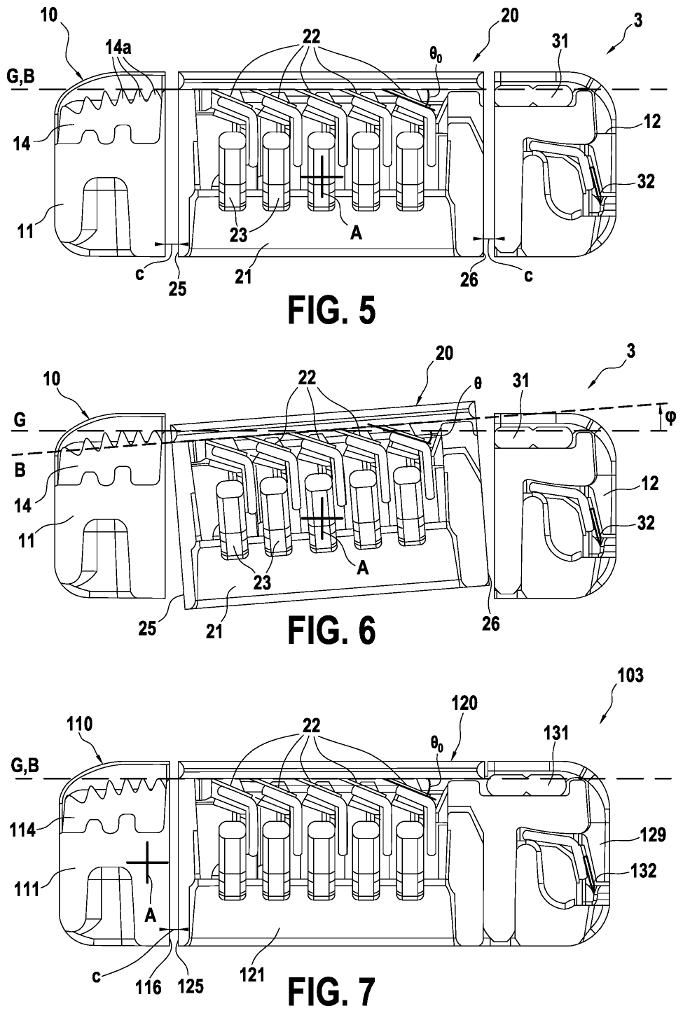

Therefore, the blade assembly 20 can be pivoted upstream and downstream around a neutral position in which the edges of the blades 22 lie on the guard plane G, that is to say in which the blade plane B is common with the guard plan G. Such a neutral state is depicted on FIG. 5. In this neutral state, each blade 22 forms a nominal blade angle θ₀ with the guard plane G. In examples, the blade assembly 20 is spring-loaded toward its neutral position: namely, the blade assembly 20 is spring-loaded whenever planes G and B create an angle φ≠0; the generated force then returns the blade assembly 20 to its rest position where planes G and B are parallel or coincide. In an example, the clearance c in the neutral state may be between 0.05-5 mm and in an example of about 2 mm and the nominal blade angle θ₀ is of about 20-30° and in an example of about 22°.

FIG. 6 now depicts a pivoted state in which the blade assembly 20 is pivoted upstream with respect to the guard base 10: thus, the blade plane B forms a positive angle φ with the guard plane G. Consequently, the blade angle θ is smaller than the nominal blade angle θ₀ and the blade exposure is therefore decreased. The amplitude of the clearances c enables to set the maximum positive angle φ authorized between the guard plane G and the blade plane B. The maximum positive angle φ may be of about 40°.

Of course, is it also possible to pivot the blade assembly 20 downstream with respect to the guard base 10. In such a case, the blade plane B forms a negative angle φ with the guard plane G. Consequently, the blade angle θ is greater than the nominal blade angle θ₀ and the blade exposure is therefore increased. Similarly, the amplitude of the clearances c enables to set the maximum negative angle φ authorized between the guard plane G and the blade plane B. The maximum negative angle φ may be of about −40°.

FIGS. 7, 8 and 9 depict a second exemplary shaving unit 103. The second exemplary shaving unit 103 is analogous to the first shaving unit 3, except for the following differences.

In this second example, the guard base 110 takes the form of a beam having a single straight portion 111 comprising a guard bar 114 analogous to that of the first example and also defining a guard plane G.

In this second example, the blade assembly 120 comprises an upstream portion 121, provided with blades 122 in an analogous way to the body 21 of the blade assembly 20 of the first example, and a downstream portion 129, provided with a lubricant strip 131 and a precision blade 132 in an analogous way to the downstream portion 31 of the guard base 10 of the first example.

The blade assembly 120 is attached to the guard base 10, along its downstream surface 116, through a blade pivot axis A extending along the transversal direction within the straight portion 111 of the guard base 110.

A clearance c is provided between the upstream surfaces 125 of the blade assembly 120 and the downstream surface 116 of the guard base 110.

Therefore, the blade assembly 120 can be pivoted upstream and downstream around a neutral position in which the edges of the blades 122 lie on the guard plane G, that is to say in which the blade plane B is common with the guard plan G. Such a neutral state is depicted on FIG. 7. In this neutral state, each blade 122 forms a nominal blade angle θ₀ with the guard plane G. The clearance c in the neutral state is between 0.05-5 mm and in an example of about 2-3 mm and the nominal blade angle θ₀ is between 20-30° and in an example 22°.

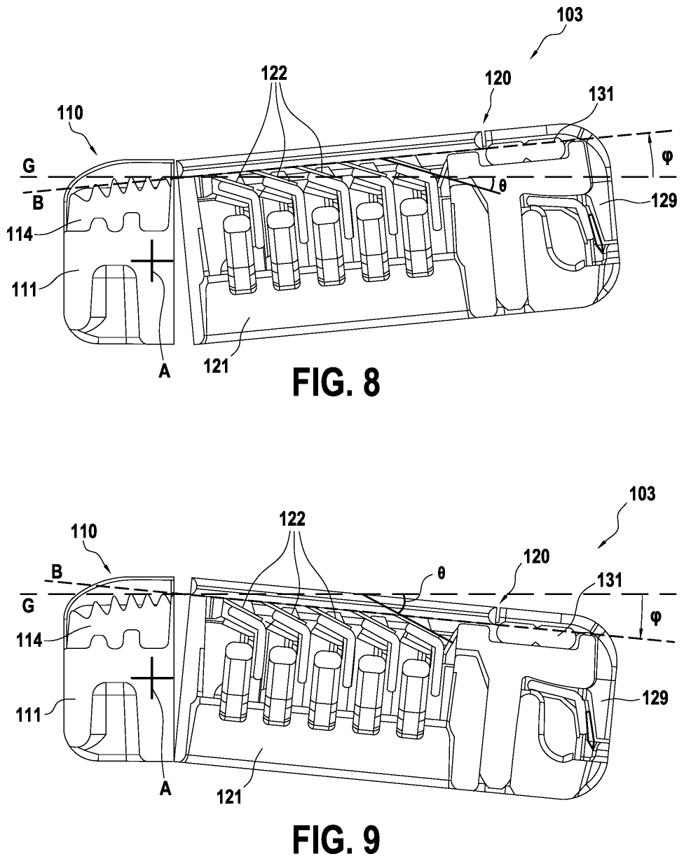

FIG. 8 now depicts a first pivoted state in which the blade assembly 120 is pivoted upstream with respect to the guard base 110: thus, the blade plane B forms a positive angle φ with the guard plane G. Consequently, the blade angle φ is smaller than the nominal blade angle θ₀ and the blade exposure is therefore decreased. It can be observed that such a positive inclination between the blade assembly 120 and the guard base 110 is particularly adapted to follow a convex skin curvature.

Conversely, FIG. 9 depicts a second pivoted state in which the blade assembly 120 is pivoted downstream with respect to the guard base 110: thus, the blade plane B forms a negative angle φ with the guard plane G. Consequently, the blade angle θ is greater than the nominal blade angle θ₀ and the blade exposure is therefore increased. It can be observed that such a negative inclination between the blade assembly 120 and the guard base 110 is particularly adapted to follow a concave skin curvature.

Even if the present disclosure has been described with regard to particular exemplary embodiments, it is clear that these examples may be modified without departing from the scope of the disclosure as defined by the claims. Particularly, individual features of different presented embodiments can be combined in additional embodiments. As a result, the description and the drawings shall be considered in an illustrative way rather than a limitative way.

It is also clear that all the features described with reference to a method are transposable, individually or in combination, to a device, and vice versa.

1. A shaving unit, comprising:
a guard base, including a guard bar and defining a guard plane, and
a blade assembly, including at least one blade extending in a blade direction and defining a blade plane,
wherein the blade assembly is pivoting with respect to the guard base about a first pivot axis (A) parallel to the blade direction.

2. The shaving unit of claim 1, wherein the guard bar is provided upstream of the at least one blade.

3. The shaving unit of claim 1, wherein the guard base is a rectangular frame including a socket in which the blade assembly is mounted, and wherein the first pivot axis extends within the blade assembly.

4. The shaving unit of claim 3, wherein the first pivot axis extends in the middle of the blade assembly in a shaving direction perpendicular to the blade direction.

5. The shaving unit of claim 3, wherein the guard base comprises a slot and the blade assembly comprises a pair of lateral surfaces, and
wherein at least one or each of the lateral surfaces of the blade assembly comprises a pin that is engaged in the slot of the guard base.

6. The shaving unit of claim 1, wherein the guard base is a beam extending in the blade direction,
wherein the blade assembly is mounted on the downstream side of the guard base, and
wherein the first pivot axis extends within the guard base.

7. The shaving unit of claim 1, wherein a clearance greater than 0.05 mm is provided between the upstream surface of the blade assembly and the guard base and/or between the downstream surface of the blade assembly and the guard base.

8. The shaving unit according to claim 1, wherein the at least one blade forms an angle (θ₀) with the guard plane and wherein the angle (θ₀) is of about 20-30°.

9. The shaving unit of claim 1, wherein the maximum amplitude of the pivotal movement between the blade assembly and the guard base is comprised between 10 and 100°.

10. The shaving unit of claim 1, wherein an angle (φ) between the guard plane and the blade plane is adjustable by hand.

11. The shaving unit of claim 1, wherein the blade assembly is spring-loaded with respect to the guard base.

12. The shaving unit of claim 1, comprising a lubricant strip,
wherein the lubricant strip is provided downstream of the at least one blade.

13. The shaving unit of claim 1, comprising a connecting portion, connected or connectable to a shaver handle.

14. The shaving unit of claim 13, comprising a second pivot axis, extending in the blade direction, about which the guard base is pivoting with respect to the connection portion.

15. A shaver, comprising:
a shaver handle, and
the shaving unit of claim 1.
